(19) United States
(12) Patent Application Publication
(10) Pub. No.: US 2017/0369164 A1
(43) Pub. Date: Dec. 28, 2017

(54) IMPROVED VISUAL MONITORING ON SMARTPHONE SCREEN

(71) Applicant: Hagai KLEIN, Oranit (IL)

(72) Inventor: Hagai KLEIN, Oranit (IL)

(73) Assignee: Selfly Camera LTD, Oranit (IL)

(21) Appl. No.: 15/540,173

(22) PCT Filed: Jun. 11, 2015
(86) PCT No.: PCT/IL2015/050592

§ 371 Date: Jun. 27, 2017

Related U.S. Application Data
(60) Provisional application No. 62/097,145, filed on Dec. 29, 2014.

(51) Int. Cl. B64C 39/02

(52) U.S. Cl. CPC B64C 39/024; B64C 2201/12; B64C 2201/027; B64C 2201/108

(57) ABSTRACT

An unmanned aerial vehicle UAV comprising a base, four extendible arms, a motor attached to each extendible arm, with a rotor coupled to each motor, the UAV further comprising a processor for controlling the motors, and a radio receiver for receiving control signals, wherein the UAV folds flat and is configured to clip onto a back of a mobile phone.

### BACKGROUND

A smart-phone is a mobile phone with an advanced mobile operating system. Smart-phones typically combine the features of a cell phone with those of other popular mobile devices, such as digital cameras, personal digital assistant (PDA), media players and GPS navigation units. Most smart-phones are camera phones that have a touch-screen user interface and which can run third-party software provided in the form of applications or ‘apps’. The computing power and functionality of the state of the art in smart-phone technology is ever increasing as is their market penetration. For example, in 2014, sales of smart-phones worldwide topped 1.2 billion, which is up 28% from 2013.

Unmanned aerial vehicles (UAV) or radio-controlled aircraft are increasingly common. Some UAVs are controlled by First-person view (FPV). Such vehicles are piloted remotely from a first-person perspective via an onboard camera, fed wirelessly to a video monitor.

The Smart-phone and UAV technologies may be combined, enabling a user to control a UAV via a smart-phone. For short-distance uses, multi-rotor UAVs are common. Such UAVs may include a camera for imaging the terrain beneath.

### SUMMARY OF THE INVENTION

An object of the present invention is to provide improved imaging via smart-phones, and in particular, to display images on the screen of smart-phones that are taken from remote viewpoints.

A second object is to provide a conveniently carried and stored UAV that can be controlled using the mobile-phone.

A third object is to provide a system including a UAV and a mobile-phone where the UAV folds flat to the dimensions of a smart-phone that may be detachably attached to a mobile phone and released and opened up into a flight configuration when necessary. Typically, the UAV includes a camera to provide remote images to the user. These images may be displayed on the screen of the mobile phone and viewed in real time.

In one embodiment, the UAV is controlled by a dedicated controller that is attached to the back of a smart-phone and is provided with input means that can be manipulated by the user, whilst viewing images taken by the camera of the UAV on the screen of the mobile-phone.

Other objects are directed to remote cameras that communicate with the smart-phone to display images therefrom on the screen thereof.

A first aspect of the invention is directed to an unmanned aerial vehicle UAV that comprises a base, four extendible arms coupled to the base, a motor attached to each extendible arm, with a rotor coupled to each motor. The UAV further comprises a processor for controlling the motors, and a radio receiver for receiving control signals, wherein the UAV may be folded flat and is configured to clip onto a mobile phone.

Preferably the motors are pivotally attached to the base and can be folded flat.

Typically, the UAV is configured to clip onto the back of the mobile phone.

Preferably, the UAV is configured to fold into a thickness not exceeding 10 mm such that it may be carried unobtrusively with a mobile phone.

Preferably, the UAV further comprises a digital camera and a transmitter.

Preferably, the UAV and controller are configured for First-person view (FPV) control.

Optionally, the control signals are transmitted from the mobile phone.

Optionally, the UAV is controllable as a First-person view (FPV) by the user monitoring the screen of the mobile phone wherein the control signals are generated by user interacting with a touch screen of the mobile phone are transmitted to the UAV by the mobile phone.

Alternatively, the UAV is controllable as a First-person view (FPV) by a user monitoring the screen of the mobile phone, a dedicated controller is provided that may be attached to the back of the mobile phone wherein the dedicated controller comprises input means that are controllable by the user, a battery, a control processor and a signal generator for receiving signals form the input controllers and for generating control signals and a transmitter for transmitting the control signals to the UAV.

Optionally, the batteries of the UAF are 3.7V LiPo (lithium-ion polymer) batteries.

Optionally, the UAV further comprises a flight control board.

In some embodiments, the the UAV further comprises a dedicated ESC coupled to the flight control board for each motor.

In some embodiments, the the UAV further comprises at least one of a battery and solar cells that are coupled to the control board.

In some embodiments, the UAV further comprises at least one sensor selected from the group comprising gyroscopes, multi-axis accelerometers, barometers, compasses, GPS units and proximity sensors coupled to the control board.

In some embodiments, the UAV further comprises a storage memory for storing digital images coupled to the control board.

Typically, the received signal from the mobile phone or from the dedicated controller is carried by a wireless communication protocol.

Typically, images from the (onboard) digital camera are transmitted to the cellular phone by a signal carried by a wireless communication protocol.

In some embodiments, the UAV has IR capability for night vision.

In some embodiments, the UAV further comprises a lamp for enhancing images taken by the camera.

In some embodiments, the UAV is provided with an ultrasonic distance sensor, similar to that used by bats.

In some embodiments, the motion of the camera is fully controlled, and the camera may provide video data that may be processed in real time to provide such that the UAV has the functionality for following a moving object.

In some embodiments, the UAF further comprises a power cable for coupling to a power supply, such that the UAF is configurable to function as a camera with motion detection.

Preferably the power cable is sheathed in a flexible rod that enables support and positioning of the UAV.

The term Smart-phone relates to cellular phones having telecommunication and camera capability that may be programmed by uploading applications.

Typically, the smart-phone has a touch screen that serves as an input-output interface to the user.

First-person view (FPV) is a technique for flying a UAV where the user sees an image from the UAV on his interface. This type of flying is also known as remote-person view (RPV) and as video piloting.

### BRIEF DESCRIPTION OF FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic perspective view of the back of a folded UAV clipped onto the back of a smart-phone;

FIG. 2 is a schematic plan view of the folded UAV of FIG. 1;

FIG. 3 is a schematic image of a dedicated controller is also shown attached to the back of the mobile phone, the UAV not shown;

FIG. 4 is a schematic perspective view of the unfolded UAV with motors in their vertical flight configuration and rotors extended wherein the dedicated controller is also shown attached to the back of the mobile phone;

FIG. 5 is a section planar view through the UAV attached to a mobile phone but with arms extended and the motors fixed on the extendible arms but folded flat, and not deployed in their flight configuration;

FIG. 6 is a perspective view of the UAV detached from the mobile phone, with arms extended and motors deployed in flight configuration;

FIG. 7 is a top view of the UAV with arms extended motors deployed in their flight position such that the axes of the motors are perpendicular to the body of the UAV;

FIG. 8 is a functional block diagram of a UAV and of a dedicated controller;

FIG. 9 is a flowchart showing how a UAV may be flown using a smart-phone;

FIG. 10 is a schematic illustration showing the UAV coupled via a flexible support to a power outlet, such that the UAV may be used as a security camera, and

FIG. 11 is a schematic illustration showing the UAV coupled via a flexible support to a table or work surface.

### DESCRIPTION OF EMBODIMENTS

Embodiments of the invention are directed to a small Unmanned Aerial Vehicle (UAV) that is effectively a detachable case for a personal communication device, such as a smart-phone. The UAV may be detached from the smart-phone, and, with the aid of fold-out rotors, is able to hover and fly. Using a dedicated application (app) running on the smart-phone the camera of the UAV is able to communicate with the smart-phone to display images to the operator on the screen of the smart-phone. Using the storage memory and other communication functions of the smart-phone, such images from the remote UAV may be streamed to and saved as video clips or still digital images on the smart-phone and subsequently transmitted to computers and other users as attached files to emails or other communications. Essentially, therefore, using a camera of the UAV, the operator is able to take aerial photographs including ‘selfies’ from a bird's eye perspective.

The motors that drive the rotors of the UAV are attached to foldaway arms and are hinged down for storage. This enables the UAV to have very small dimensions, suitable for it to be carried in a pocket and attached to a smart-phone as a smart-phone case.

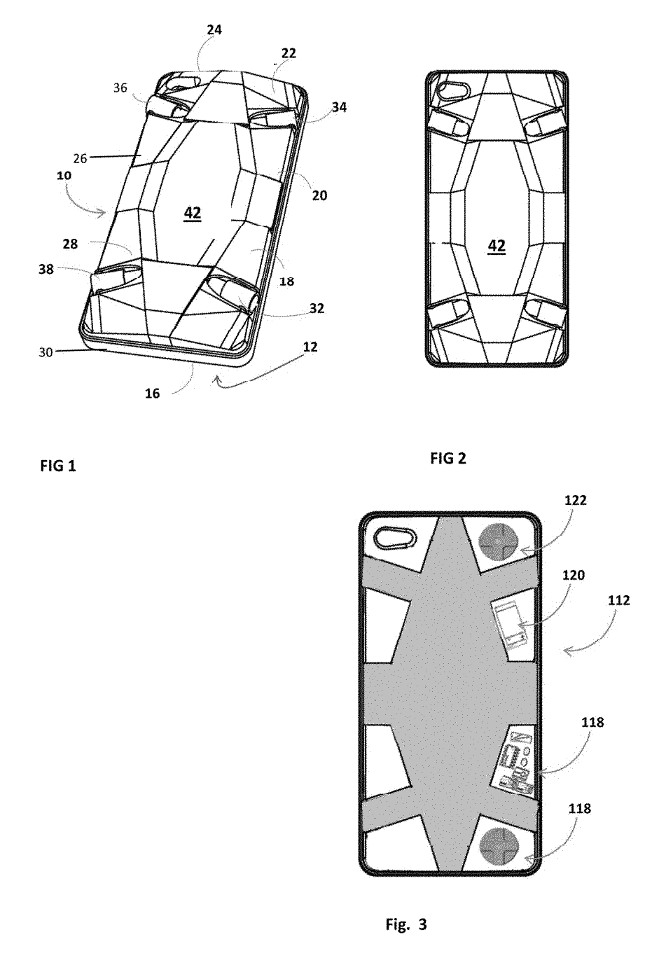

With reference to FIGS. 1 and 2 a schematic image of a folded UAV 10 on the back of a smart-phone 12 is shown. It is a feature of the present invention, that the UAV 10 may be folded down to the dimensions of a smart-phone 12 and attached to the back of the smart-phone 12, typically clipping onto the smart-phone 12 using springy plastic clips 14 (best seen in FIG. 7) that clip over and latchingly engage the sides of the smart-phone 12.

In some embodiments, the areas 16-30 around the folded UAV 10 are the back of the mobile phone 12, and the UAV 10 protrudes from the back of the smart-phone 12. In other embodiments, as shown clearly in FIG. 3 which shows the back of a smart-phone 112 with the UAV separated therefrom and not shown, some or all of areas 116-130 may be built up to the height the smart-phone (not shown) to provide a smooth back when the folded UAV 10 is clipped to the smart-phone 112 such the smart-phone 112 with UAV 10 attached can be carried as a regular smart-phone without the UAV 10 protruding in a way that elements of it's delicate structure do not protrude beyond the areas 116-130 that provide mechanical bulk and serve as bulwarks to protect the delicate structure of the UAV 10.

Furthermore, some or all the protrusions 116-130 may serve as a housing for a dedicated controller for the UAV 110 that is provided on the back of the mobile phone 112 such some combination of the areas 116-130 contain a processor, a memory and transmitter and, for flying the UAV 110, may serve as input keys or may have joysticks attached thereto.

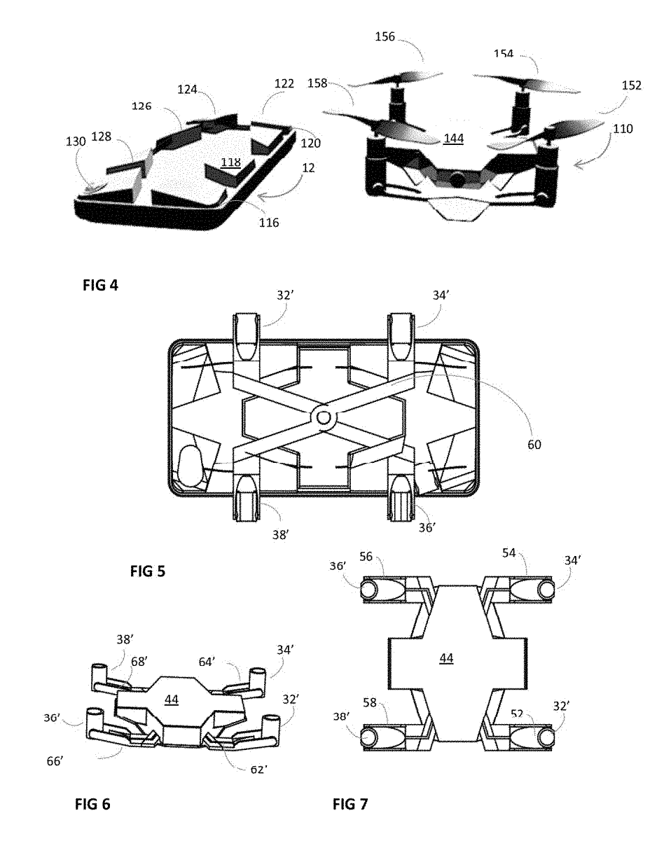

The UAV 10 shown on the back of the smart-phone 12 in FIGS. 1 and 2 may be opened up into its flight configuration. With reference to FIG. 4, a schematic image of the UAV 110 is shown in its unfolded, flight configuration, with motors 132-138 repositioned perpendicular from the base 144 and with rotors 152-154 shown. the uppermost surface of which 144 was in contact with the back of the mobile phone 112.

With reference to FIG. 5, there is shown a section planar view through the UAV 10′ still attached to the smart-phone 12′, but with the extendible arms 62-68 of the UAV 10 that carry the rotors on their individual motors 32-38 in their extended configuration. The motors 32-38 themselves are shown lying flat. The motors 32-38 are pivotably coupled to the arms 62-68 of an X shaped insert 60 which may extend from the body of the UAV 10.

With reference to FIGS. 6 and 7 showing the UAV of FIG. 5 is shown in perspective and plan views, with the arms 62′-68′ extended and with the motors 32′-38′ pivoted into their upright position. The rotor blades 52-58 are also shown in FIG. 7.

It will be appreciated that the further apart the rotors 72-78 are situated, the more stable and controllable the flight. The motors 32-38 are configured to fold down for storage and to pop up or fold up to assume a flight configuration where they are perpendicular to the base 44 of the UAV 10. The rotors 72-78 are fixed pitched propellers. The rotor blades of each rotor 72-78 are hingedly attached to a spindle of one of the motors 32-38 so that on rotation, centrifugal force and the down thrust from each spinning rotor blade causes the rotor blade to rise to assume configurations perpendicular to the spindle of the motor to which it is attached. Cessation of power to the motors 32-38 causes the rotors 52-58 to fall back into parallel alignment with the spindle. The motors 32-38 are configured such that two rotors, e.g. 52, 56 situated cater-corner rotate in a clockwise direction and the other two rotors e.g. 54, 58 rotate in a counter-clockwise direction.

The communication between the UAV 10 and the mobile-phone 12 or dedicated controller 200 attached to the mobile-phone 12 may use an RF frequency such as 2.4 GHz, or an optical channel. Various wireless communication protocols such as Wi-Fi, BlueTooth, IR, 3G may be used. In order to fly, the UAV 10 may be detached from the mobile phone and unfolded so that thrust can be generated by rotors 62-68 attached to the four vertically oriented motors 32-38. Optionally, despite the four motors, the UAV 10 may be flown using only two controls.

The ‘fuselage’ 42/44 of the UAV 10 includes a cellular phone crib. This may be customized for specific smart-phone models or provided as a universal crib for different smart-phone models.

As shown in FIG. 4, the UAV 110 may be detachably attached to the back of the mobile-phone 112 (or to a mobile phone case). In other embodiments, the UAV may be attached to the front of a mobile phone or hinged to a mobile phone in a manner analogous to the cover of a book.

The smart-phone 12 is programmed, typically by providing an application (‘app’) which coordinates the communication between the UAV and the cellular phone, controlling the camera of the UAV and managing the movies and photos.

Two embodiments for controlling the flying of the plane are now described.

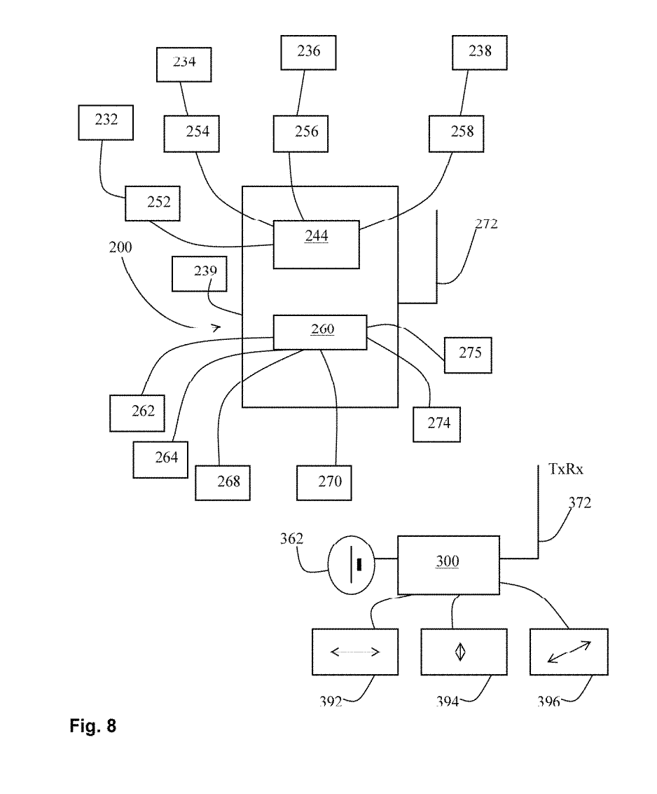

With reference to FIG. 8, a functional block diagram of a UAV 200 and of a dedicated controller 300 are shown.

The UAV 200 consists of a base or fuselage 244 to which are coupled the four rotors 252-258 on the servomotors 232-238 by extendible arms 252-258. Optionally, there is an additional servomotor 239 for controlled the extension of the arms 232-238. Alternatively, the arms 232-238 may be spring loaded, and extension of the arms 232-238 may be manually initiated by a push button, for example.

The UAV 210 further includes a battery power source 262 and optionally, solar panels 264 on top and bottom surfaces of the base or fuselage 244. A board 260 is provided to which the battery 262, solar panels 264, memory 266, processor 268, a camera 270, and a reception, transmission antenna RxTx 272 are attached. Preferably, one or more sensors 274 such as gyroscopes, multi-axis accelerometers, barometers, compasses, GPS units and proximity sensors are provided for detecting tilt, acceleration and movement, air pressure, absolute location and the distance of the UAV 210 from the controller and/or other objects is provided.

The controller may be a dedicated controller 300 that is built into an attachment that is fixed onto the back of the smart-phone 12 or may be the smart-phone itself.

Where a dedicated controller 300 is provided, the controller 300 includes a battery 362, a transmitter 372 and user directional controls 392, 394, 396 for steering in three dimensions (X, Y and Z). The directional controls 392, 394, 396 may be joysticks or may push buttons but may also be touch-screen like press, release and slide sensitive panels. The input means may allow for varying the rotor speed and controlling the left-right, up-down, forwards and backwards movement of the UAV 200. Minimally, two controls are provided.

In some embodiments, ultrasonic distance sensors 275 are provided.

The UAV 200 receives control signals from the controller and using input from the various sensors 274, decides how much power to provide each of the four motors to implement the instructions from the controller. The motors 232-238 themselves may be coreless motors.

Where the controller is a dedicated controller 300 attached to the back of the smart-phone 12, the user may view the images streamed from the camera 270 of the UAV 200 on the screen of the smart-phone 12, using the whole screen to provide the image and/or additional data. The fingers of the user under the smart-phone 12 may operate the directional controls 392, 394, 396 without obstructing the field of view on the screen of the smart-phone 12.

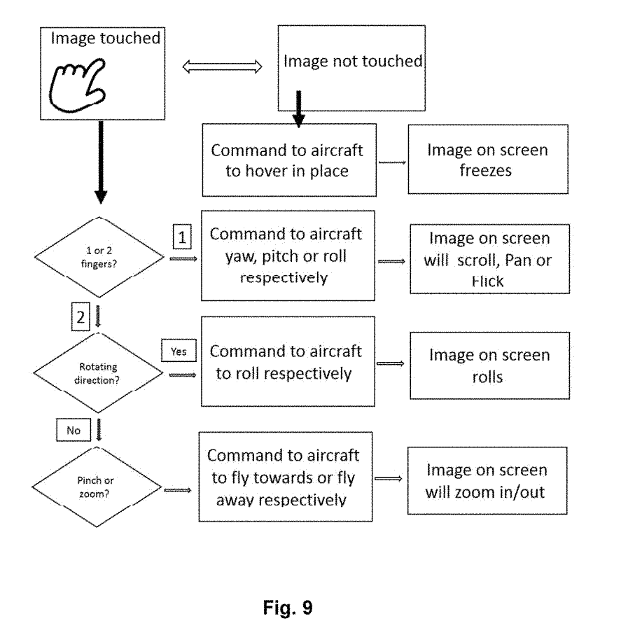

With respect to the flowchart of FIG. 9, in embodiments where the smart-phone 12 itself is used to control the flying of the UAV, pressing on different parts of the screen swiping and the like may be used to control the flight of the UAV 210, the interface may be an ‘operating cockpit screen’ or the application may be programmed such that the orientation of the smart-phone 12 itself may be twisted and turned such that the gravity sensor and gyroscopes of the smart-phone are used to control the UAV 210.

In some embodiments, the UPV 210 streams real time video images to the smart-phone 12 for piloting as a FPV vehicle. The user input may be provided by manipulating the image through simple or multi-touch gestures by touching the on-screen image to transform by reducing, enlarging (pinch to zoom), rotating or shifting the image displayed on the screen. The transformation may be converted into flight orders which are transmitted to the UPV 210.

For example, a sliding separation of the thumb and forefinger of the user on the screen of the smart-phone 12 may cause the image from the camera 270 of the UAV 210 that is shown on the screen of the smart-phone 12 to be enlarged, whereas a sliding together of the thumb and forefinger of the user on the screen of the smart-phone 12 may cause the image from the camera 270 of the UAV 210 that is shown on the screen of the smart-phone 12 to pan outwards giving a wider field of view. Touching the screen with a finger and then moving the finger in the desired direction on the screen as a “sweeping motion” of the user's finger along the screen may cause a displacement of the displayed image in the same direction. The smart-phone 12 application may translate the finger motion to flight control orders that causes the UAV 210 (and camera 270) to respond respectively to the motion of the finger along the screen. With appropriate autonomous flight support systems, applications of this method may require no conscious flying skills on the part of the user, who may interactively control the image by conventional known touch screen methods without considering flight parameters of the UPV 210.

In the embodiments described and shown, the UAV is a ‘quad copter’ with four motors and rotors, but it will be appreciated that in other embodiments, different types of helicopters, with different numbers of motors, such as helicopters with 3 motors may be used.

The motors themselves are preferably brushless motors. In the 4 motor design the motors location can form an X or +(cross) formation where the motors in opposite corners (e.g. 232, 236) spin in one direction (e.g. clockwise CW) and the other two motors (e.g. 234, 238) spin in the opposite direction, e.g. counter-clockwise (CCW) thereby producing opposite torques for stable flight.

The flight control board 260 of the UAV 210 receives signals from the application on the smart-phone 12, processes the integrated data from all the sensors 274 and outputs orders that control the motors 252-258 as required. Integration of the combined input from all the sensors 274 provides the UAV 210 with the ability to keep a hovering steady flight independently, enabling it to fly autonomously to a defined location, to come back to the launch point, or, by using video processing, to follow a moving object.

Embodiments of the invention may be configured to operate anywhere within any supported network; Wi-Fi, Blue Tooth or cellular networks, thus the UAV 10, 110, 210 may fly in a location at a distance from the user.

The UAV 10, 110, 210 has a receiver 272 for receiving control signals from the ‘pilot’, either via the smart-phone 12 or from the dedicated controller 300 attached to the smart-phone 12. In preferred embodiments, the UAV 272 transmits signals, such as image data to the mobile-phone 12. Both transmitted Tx and received Rx signals may be any of a wide range of wireless communications, including but not limited to Wi-Fi, Blue Tooth, IR or 3G.

The camera 270 generally has both video and still photography capability and the option to save directly in an on-board memory 266 and/or send to the cellular application for displaying on the screen of the smart-phone. It enables FPV via real time video streaming. The camera 270 may have IR capability thereby offering night imaging capability. Furthermore, in some embodiments, the APV 210 includes a lamp 290, typically, LEDs to provide illumination.

Usefully, the APV 210 has ‘Follow Me Capability’, processing the video data received and controlling the motion of the camera 270 in all axes to enable the following of a moving object.

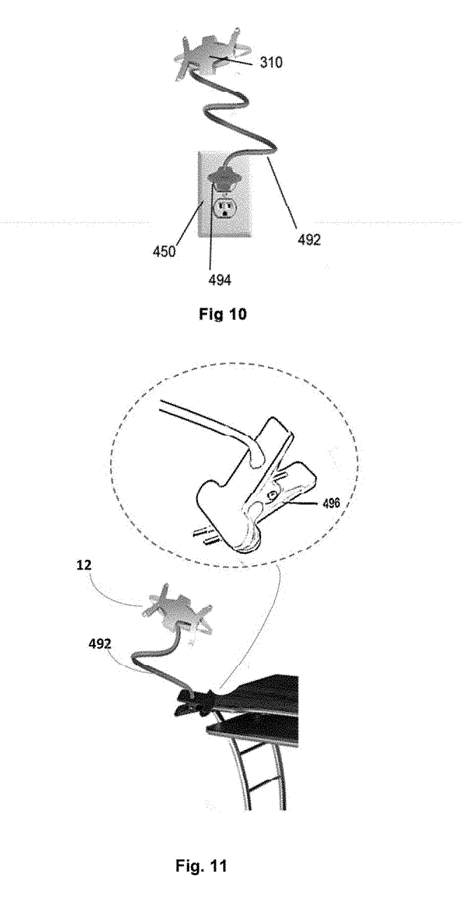

With reference to FIG. 10, although designed primarily for flight purposes, it will be appreciated that the APV 310 may be connected to an external electric source 450 by a stiff and bendy support cable 492 terminating with a plug 494. In some embodiments, the APV 410 may be inductively charged. Referring to FIG. 12, the a clip 496 may be provided at the end of the stiff and bendy support cable 492 and positioned in a stationary location to serve as a Camera Recorder, CCTV camera or security camera, or in a vehicle to serve as a DVR, either streaming images to the smart-phone for storage or retransmission, possibly to the Internet Cloud.

Typically, the APV will be provided with and powered by batteries 262, such as by 3.7V LiPo (lithium-ion polymer) batteries, for example. Due to weight and space considerations the energy source may be divided to a number of smaller batteries that can be connected in series and/or parallel to provide appropriate current and voltage.

In some embodiments, the back of the case may be coated by solar cells 264, making the system energy independent. This feature combined with 3G communication capability provides unprecedented degrees of freedom.

As shown in FIG. 11, the APV 210 may be connected to an external electric source 490 by cable 492 and thus it can perform as a security camera, Car DVR Camera Recorder, CCTV camera, night vision security camera, motion detective starts when an object moves.

When the APV is in its crib, the battery 262 thereof will be connected to the battery of the smart-phone, enabling the APV 10 and the smart-phone 12 to balance charging with each other on the basis of need. Given the fact that the APV 10 has solar charging capability, it can help the overall energy consumption of the smart-phone 12.

Thus the UAV described herein is a complementary system for a cellular phone that provides an additional detachable camera that may be independently located and which communicates with the base phone. If simply placed on a shelf or other support this may serve as a stationary security camera. In such a configuration, the battery may be charged either via a power lead from a mains socket, or inductively from a powering surface, such as those developed by Powermat.

It is a particular feature that the UAV may be flown under the user's control, providing the user with the ability to see, photograph and experience from a distance from the user's position.

Unlike other UAV's embodiments of the present invention have a minimalistic design that provides a pocket size product that is comfortable to carry and use as a case for the smart-phone itself.

Thus persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. An unmanned aerial vehicle UAV comprising a base, four extendible arms, a motor attached to each extendible arm, with a rotor coupled to each motor, the UAV further comprising a processor for controlling the motors, and a radio receiver for receiving control signals, wherein the UAV folds flat and is configured to clip onto a back of a mobile phone.

2. The UAV of claim 1, configured to fold into a thickness not exceeding 10 mm such that it may be carried unobtrusively with a mobile phone.

3. The UAV of claim 1 comprising 3.7V LiPo (lithium-ion polymer) batteries.

4. The UAV of claim 1 further comprising a digital camera and a transmitter.

5. The UAV of claim 4 configured for First-person view (FPV).

6. The UAV of claim 1, wherein the control signals are transmitted from the mobile phone.

7. The UAV of claim 4 being controlled as a First-person view (FPV) by a user monitoring the screen of the mobile phone wherein the control signals are generated by user interacting with a touch screen of the mobile phone are transmitted to the UAV by the mobile phone.

8. The UAV of claim 4 being controlled as a First-person view (FPV) by a user monitoring the screen of the mobile phone and wherein the control signals are generated by a dedicated controller attached to the back of the mobile phone wherein said dedicated controller comprises input controllers controllable by the user, a battery, a control processor and signal generator for receiving signals form the input controllers and for generating control signals and a transmitter for transmitting the control signals to the UAV.

9. The UAV of claim 1 further comprising a flight control board.

10. The UAV of claim 9 wherein the flight control board further comprises ESCs for the motors.

11. The UAV of claim 9 wherein the flight control board further comprises at least one sensor selected from the group comprising gyroscopes, multi-axis accelerometers, barometers, compasses, ultrasonic distance sensors, GPS units and proximity sensors.

12. The UAV of claim 9 further comprising a storage memory for storing digital images.

13. The UAV of claim 6 wherein the received signal from the mobile phone is carried by a wireless communication protocol.

14. The UAV of claim 6 wherein the received signal from the dedicated controller is carried by a wireless communication protocol.

15. The UAV of claim 4 wherein images from the digital camera are transmitted to the cellular phone by a signal carried by a wireless communication protocol.

16. The UAV of claim 4 wherein the camera has IR capability for night vision.

17. The UAV of claim 4 further comprising an illuminator for enhancing images taken by the camera.

18. The UAV of claim 10 wherein the motion of the camera is fully controlled, and wherein the camera provides video data that may be processed in real time to provide such that the UAV has functionality of following a moving object.

19. The UAV of claim 3 further comprising a power cable for coupling to a power supply, such that the UAV is configurable to function as a camera with motion detection.

20. The UAV of claim 19 wherein the power cable is sheathed in a flexible rod that enables support and positioning of the UAV.
